(19) United States
(12) Patent Application Publication
(10) Pub. No.: US 2026/0303368 A1
(43) Pub. Date: Oct. 1, 2026

(54) Client-Side Decryption for Cloud-Based Security Services

(71) Applicant: Zscaler, Inc., San Jose, CA (US)

(72) Inventors: Loren Weith, Waterville, OH (US); Lidor Pergament, San Jose, CA (US)

(73) Assignee: Zscaler, Inc., San Jose, CA (US)

(21) Appl. No.: 19/095,631

(22) Filed: Mar. 31, 2025

(51) Int. Cl. H04L 9/32

(52) U.S. Cl. CPC H04L 9/3263

(57) ABSTRACT

Systems and methods for client-side decryption include intercepting, via an agent application installed on a client device, a secure connection request originating from a browser or other application executing on the client device; extracting, by the agent application, handshake parameters from the secure connection request; establishing a secure session between the agent application and the browser using a locally generated decryption certificate and the handshake parameters; decrypting, by the agent application, data received from the browser and conditionally inspecting and re-encrypting the decrypted data for transmission to a cloud-based system or a destination server.

### FIELD OF THE DISCLOSURE

The present disclosure generally relates to network and cloud security. More particularly, the present disclosure relates to systems and methods for client-side decryption for cloud-based security services.

### BACKGROUND OF THE DISCLOSURE

Organizations increasingly rely on secure network connections to protect sensitive data exchanged between users’ devices and destination servers. Traditional approaches to Secure Sockets Layer (SSL) or Transport Layer Security (TLS) inspection often place decryption duties on a centralized proxy or gateway, which holds a private key to inspect traffic for threats, data loss, and compliance violations. However, if the proxy’s key or Certificate Authority (CA) is compromised, every device relying on that proxy becomes vulnerable, a problem known as the expanded “blast radius.” Moreover, such a centralized model can introduce latency and high computational overhead, as the proxy must continuously negotiate TLS handshakes on behalf of every client. The present invention addresses these challenges by shifting decryption operations to the client side. By deploying an agent application that intercepts and decrypts SSL/TLS traffic locally, organizations reduce their risk footprint, eliminate continuous high-load cryptographic tasks on the proxy, and still maintain full visibility into encrypted traffic for policy enforcement.

### BRIEF SUMMARY OF THE DISCLOSURE

The present disclosure relates to systems and methods for client-side decryption for cloud-based security services. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include intercepting, via an agent application installed on a client device, a secure connection request originating from a browser or other application executing on the client device; extracting, by the agent application, handshake parameters from the secure connection request; establishing a secure session between the agent application and the browser using a locally generated decryption certificate and the handshake parameters; decrypting, by the agent application, data received from the browser and conditionally inspecting and re-encrypting the decrypted data for transmission to a cloud-based system or a destination server.

The steps can further include wherein the handshake parameters include a Server Name Indication (SNI) and cipher suite preferences. Establishing a secure session can include forwarding, from the agent application to the cloud-based system, the handshake parameters, a Server Name Indication (SNI), and cipher suite preferences; receiving, at the agent application from the cloud-based system, a response indicating a finalized server-facing Transport Layer Security (TLS) configuration, the configuration including a chosen cipher suite, a certificate chain, and any relevant session details; and locally generating, by the agent application, a decryption certificate derived from the server-facing certificate chain and mirroring essential cryptographic attributes of the server-facing certificate. The steps can include verifying, at the agent application, an authenticity of the certificate chain presented by the destination server against a local or operating system-level trust store prior to locally generating the decryption certificate. The locally generated decryption certificate can be signed by a local Certificate Authority (CA) key stored securely on the client device, the local CA key being different from a cloud-based or network-based CA key. The steps can further include performing policy-based inspection on decrypted data, including at least one of threat detection, Data Loss Prevention (DLP), or Uniform Resource Locator (URL) filtering, prior to re-encrypting the data for forwarding. The steps can include establishing, via the agent application, a second secure session with the cloud-based system, such that decrypted data is re-encrypted before leaving the client device, thereby maintaining confidentiality in transit.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of a process for performing SSL interception through an interception proxy in a handshake process.

FIG. 6 is a network diagram of a network with a node configured as an interception proxy.

FIG. 7 is a flow diagram of an embodiment of the present systems and methods for client-side decryption.

FIG. 8 is a flowchart of a process for client-side decryption.

### DETAILED DESCRIPTION OF THE DISCLOSURE

Again, the present disclosure relates to systems and methods for client-side decryption for cloud-based security services. The present invention alleviates the shortcomings of traditional proxy-based decryption by relocating critical SSL/TLS decryption responsibilities to the client side. Instead of forcing a centralized proxy to handle every incoming and outgoing encrypted session, an agent application on each user device intercepts and decrypts the traffic locally. This design sharply reduces the operational and computational burden on the proxy, as it no longer needs to perform constant, high-load cryptographic tasks for all endpoints.

Moreover, this approach dramatically limits the blast radius in the event of a compromised certificate or key. Each client device manages its own local CA key, thereby containing the risk to a single endpoint instead of placing the entire organization at risk. At the same time, policy enforcement remains robust because the agent application provides the organization with full visibility into decrypted data whenever necessary for threat prevention, data loss protection, or compliance audits.

By distributing the workload, organizations can streamline their security processes, reduce latency, and scale their defenses more efficiently. Ultimately, this decentralized client-side architecture balances rigorous security checks with improved performance, making it an ideal solution for environments requiring both high throughput and strong data protection.

### 1.0 Cybersecurity monitoring and protection examples

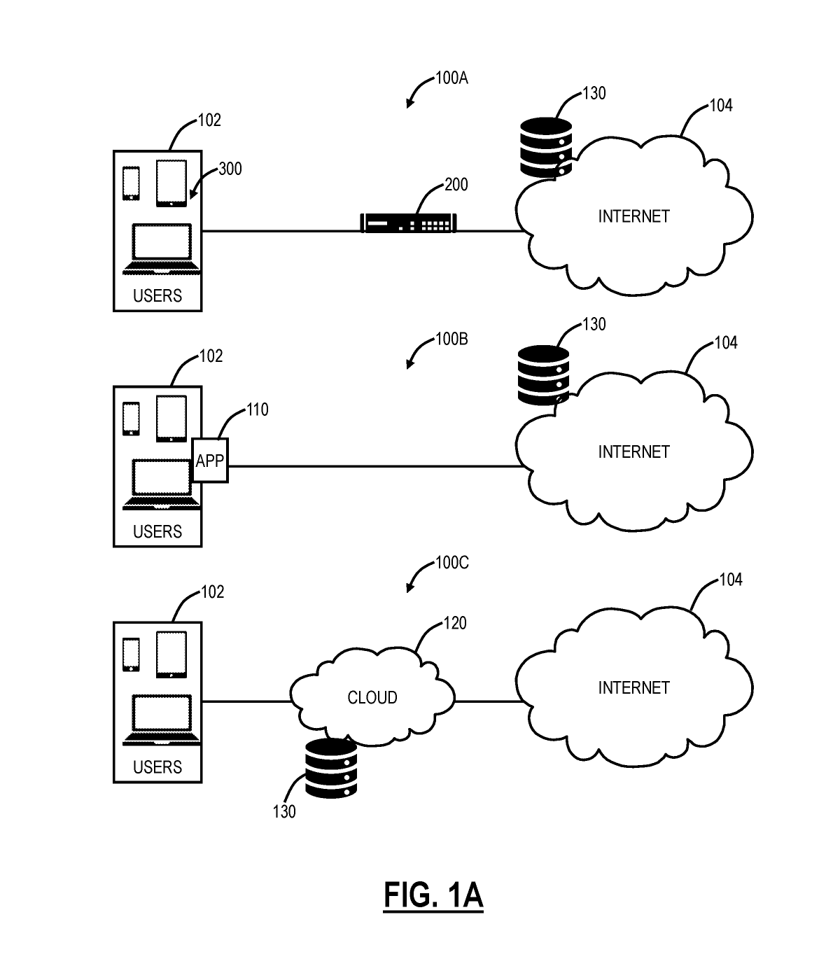

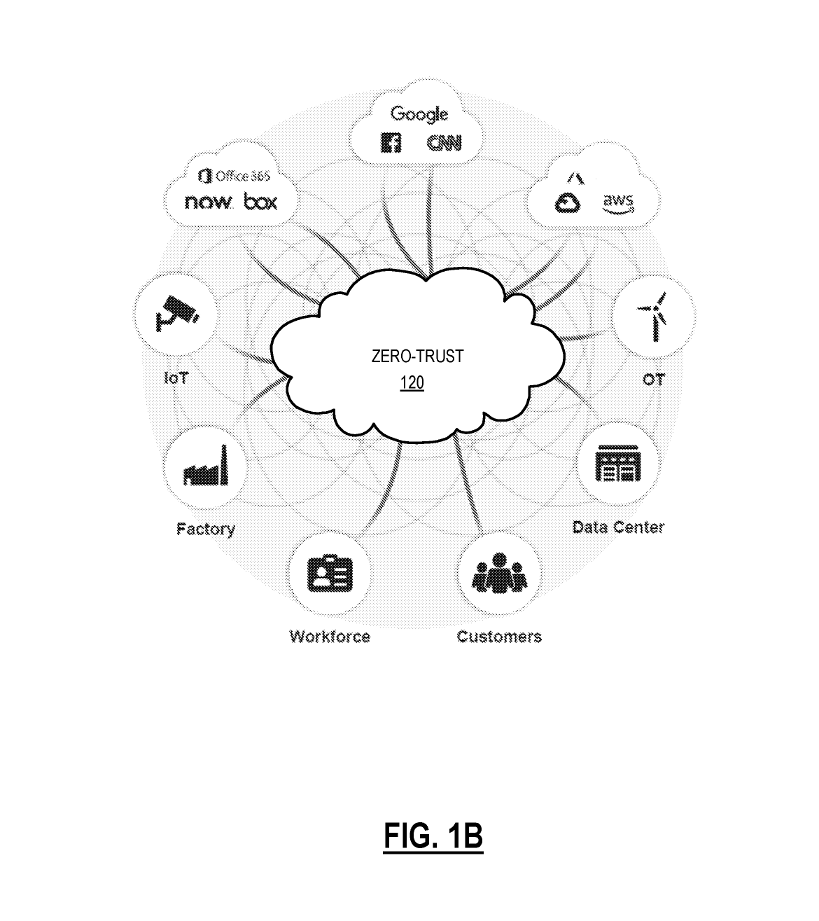

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

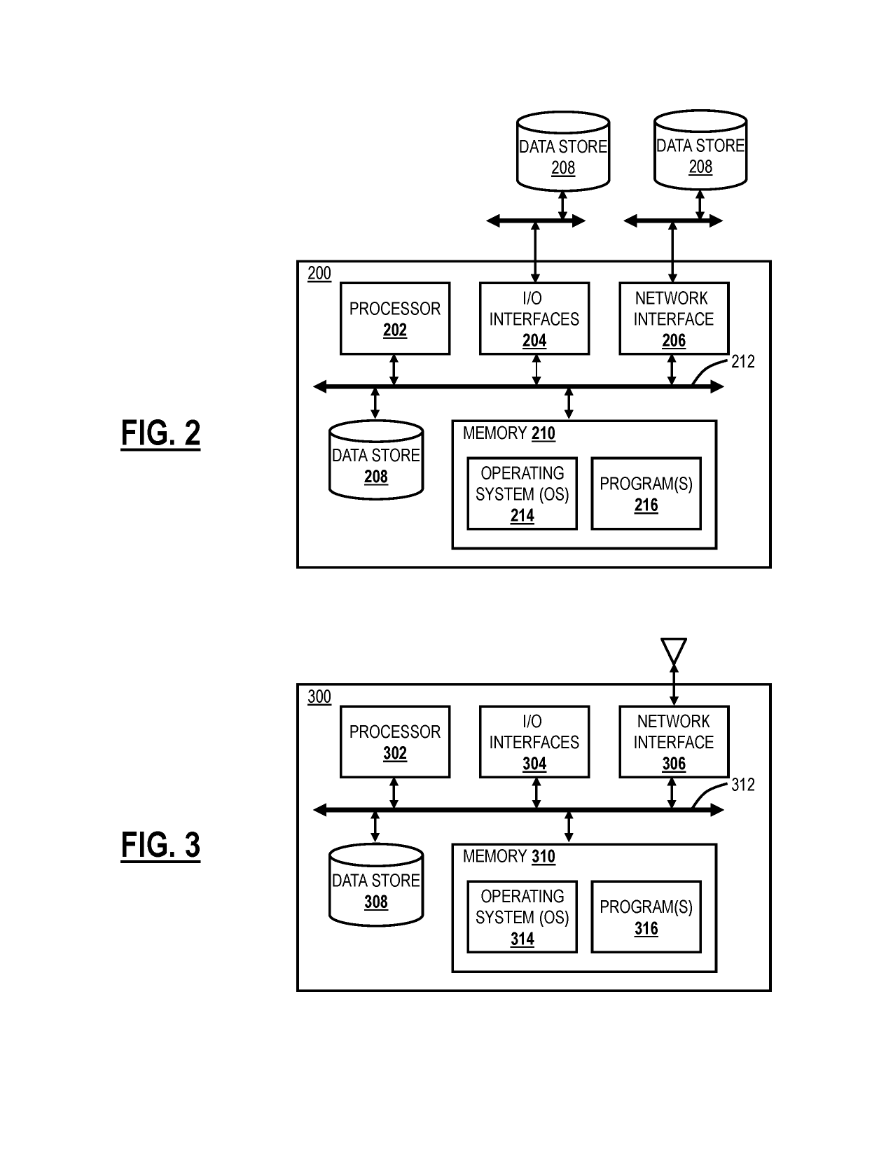

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer’s data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### 1.1 Cloud monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client’s web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### 1.2 Zero trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### 1.3 LOG DATA

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

### Also, such data is described in the following

Commonly-assigned U.S. Patent No. 8,429,111, issued Apr. 23, 2013, and entitled “Encoding and compression of statistical data,” the contents of which are incorporated herein by reference, describes compression techniques for storing such logs,

Commonly-assigned U.S. Patent No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. Patent Application No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user’s 102 activity. That is, the log data 130 is not merely confined to specific activity (e.g., a user’s 102 social networking activity on a specific site, a user’s 102 search requests on a specific search engine, etc.).

### 2.0 Example server architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc..

### 3.0 Example computing device architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### 4.0 Application for traffic forwarding and monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

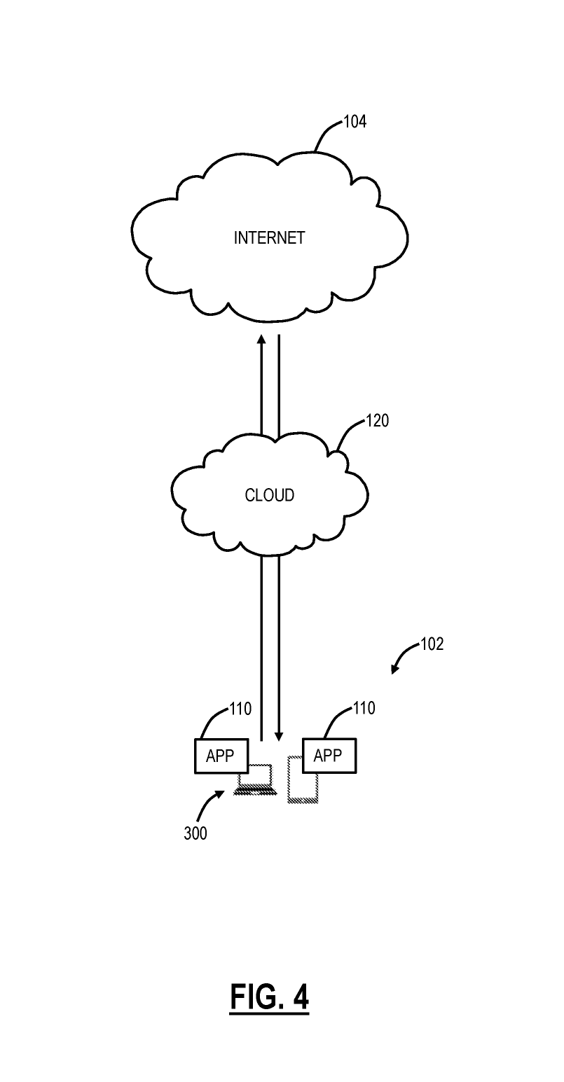

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### 5.0 SSL interception proxies

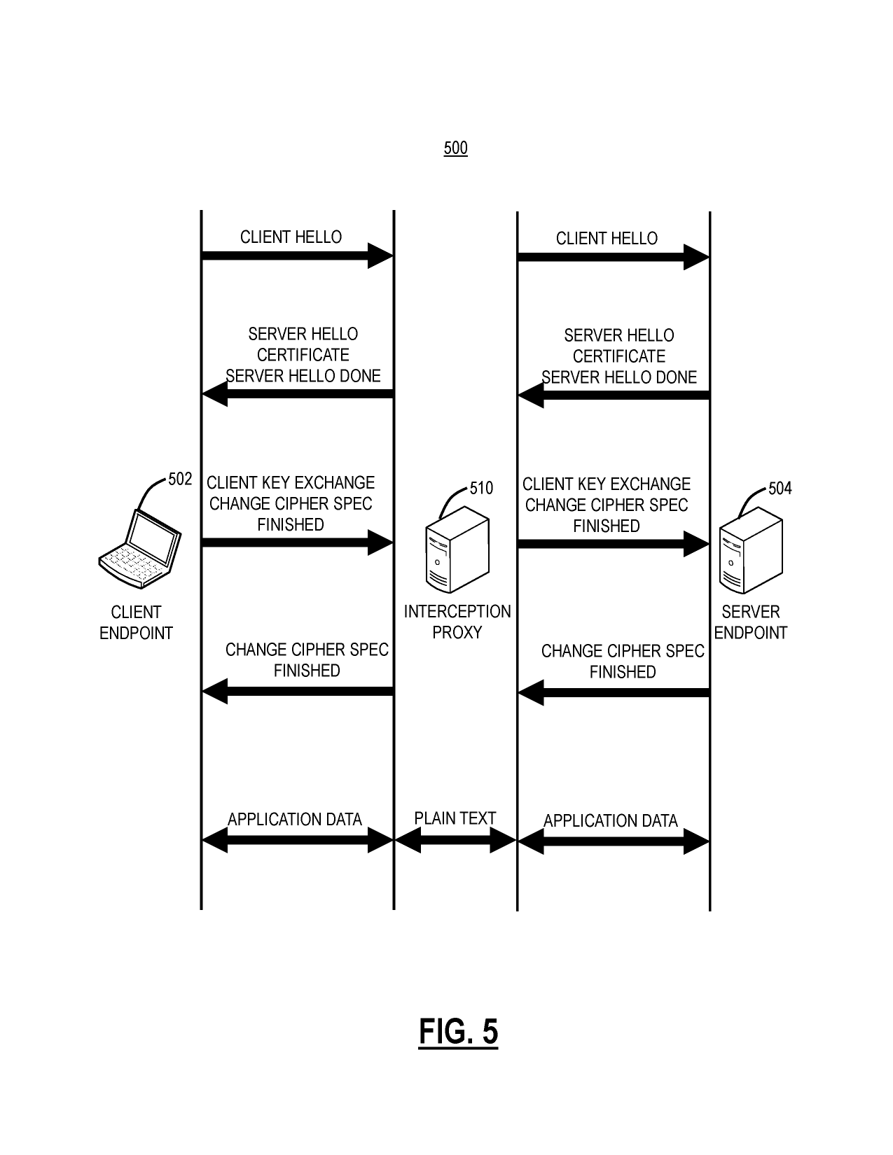

FIG. 5 is a flow diagram of a process 500 for performing SSL interception through an interception proxy 510 in a handshake process. The interception proxy 510 can be a node of the cloud 120. Enterprises deploy or use the interception proxy 510 to secure themselves from SSL-based threats, which are increasingly common. The interception proxy 510 works by acting as a Man-in-the-Middle (MitM) and modifying the encrypted channel. Whenever an SSL client 502 initiates a connection to a remote SSL server 504, the interception proxy 510 will intercept it and open two different channels of communication, one with the SSL client 502 and the other with the SSL server 504 that the SSL client 502 intended to talk to in the first place. This allows the interception proxy 510 to actively modify/inject the content from the SSL client 502 to the SSL server 504 or vice versa. This allows IT admins to perform malware scanning and other security functions on the otherwise encrypted content. In order to achieve this, an IT admin usually deploys proxy’s ROOT Certificate Authority (CA) certificate on the computing devices 300 for the SSL clients 502 to trust the handshake which happens between the SSL client 502 and the interception proxy 510 which generates a certificate for every SSL server 504 that the SSL client 502 tries to communicate with. This naturally breaks with apps that employ certificate pinning for enhanced security.

Advantageously, the interception proxy 510 enables interception, inspection, and filtering of content on an otherwise encrypted channel. For example, the cloud-based system, i.e., the cloud 120, using the interception proxy 510 can perform Data Loss Prevention (DLP), web content filtering, malware detection, intrusion detection/prevention, firewall and Deep Packet Inspection (DPI), etc. The interception proxy 510 acts as the SSL client 502 on the SSL server 504 side and as the SSL server 504 on the SSL client 502 sides.

The interception proxy 510 performs SSL inspection by breaking or terminating the encrypted tunnel in the cloud-based system 120. Specifically, the node is a proxy, and it has an encrypted tunnel with the client and another encrypted tunnel with the server. That is, this approach requires SSL/TLS/DTLS handshake/termination on the node (in the cloud 120, on-premises, etc.). This approach, with the node as a MitM proxy breaking the tunnel has limitations. Specifically, some applications use Certificate Pinning or other techniques to prevent MitM. With Certificate Pinning, the client is configured to only accept a specific certificate or a specific CA. In this case, the application will break when presented with a certificate signed by the cloud-based system 120, even if it is trusted.

This is done to ensure greater control over the communicating entities and to prevent the MitM attacks. The situation is somewhat of a paradox: entities such as Domain Name Systems (DNS) and CAs are trusted and supposed to supply trusted input. However, more and more applications are trying hard with pinning to eliminate this conference of trust. By pinning the certificate or the public key of the server certificate, an application no longer needs to depend on third-party entities such as DNS, CA, etc. when making security decisions relating to a peer’s identity. This makes an app immune to MitM attacks. Pinning effectively removes the “conference of trust” by eliminating the set of entities that are beyond the control of a domain owner. Apps achieve this by accepting server certificates that strictly match a defined criterion, usually subject key information.

With the SSL interception, proxy servers are employed in the cloud-based system 100 are aware of the SSL encrypted communication and may need to intercept it in order to provide security services. Such filtering solutions are generally achieved through interception proxies that engage in deep packet inspection to resist SSL-based threats that may range from trivial viruses to sophisticated ransomware. The problem when apps employ certificate pinning is that they reject the connection during negotiation with an interception proxy on account of peer’s (in this case, SSL proxy) untrusted certificate.

Such apps fail to function in the enterprise environment and fail to provide desired services leading to bad user experience and frustration. The apps would be rendered dysfunctional partially or completely due to the certificate pinning employed by them. They will terminate the connection upon receiving a server certificate from the proxy that does not match the criterion. This leads to bad user experience, and the cloud security system does not have any visibility or resolution of such issues.

As more and more viruses use encrypted channels to infect machines, it is imperative for enterprises to employ SSL interception proxies to protect users. This poses a conundrum as app developers would like to eliminate trust on third parties like CAs, which may be vulnerable to other attacks. To solve this issue, an IT admin may be lured to turn SSL interception off, which makes their enterprise security even worse. Hence, it is desirable for IT admins to selectively turn SSL interception off only for some trusted applications and domains. Since it is very hard for IT admins to know which apps users will use or what domains the app may hit, which may even change over time, there is a huge need for a better tunneling solution.

### 6.0 SSL interception

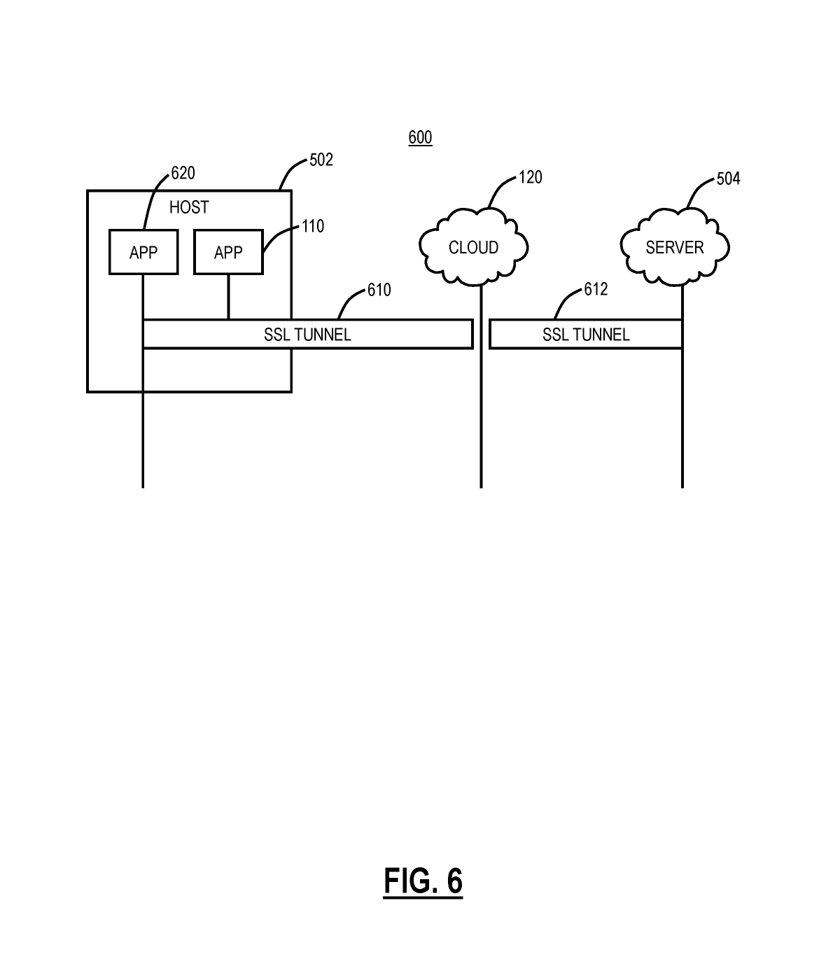

FIG. 6 is a network diagram of a network 600 with a node configured as an interception proxy 510. As such, an interception proxy 510 in the cloud-based system 120 can selectively intercept SSL communications. In an embodiment, Internet-bound traffic of the computing device 300 (the SSL client 502) is controlled through a tunnel 610 to the cloud-based system 120 which has a second tunnel 612 to the SSL server 504. The tunnel 610 acts as an intermediary passive MitM proxy that relays all the network requests and responses from client applications 620 to the cloud-based system 120. To achieve this, a process running on the host (the SSL client 502) installs a virtual interface on the computing device 300. The process installs a default route on the interface in the device routing table and opens listening sockets for User Datagram Protocol (UDP) and Transmission Control Protocol (TCP) traffic at randomly available ports.

### 7.0 Client side decryption

Client-side decryption is a feature in the described cloud security platform, cloud 120, designed to enhance security and data privacy for organizations. This feature ensures that sensitive data remains protected end-to-end by decrypting encrypted traffic at the endpoint (client-side) rather than within the cloud infrastructure. Client-side decryption involves decrypting SSL/TLS traffic on the user's device (computing device 300) before it is inspected by the cloud 120. This method maintains the integrity and confidentiality of sensitive data while still allowing the cloud 120 to perform its security functions, such as threat detection, DLP, and policy enforcement.

As described, the agent application 110 is a lightweight agent installed on the user's device. It intercepts internet-bound traffic and applies security policies configured by the organization. When a user initiates a connection to a secure website, agent application 110 intercepts the SSL/TLS handshake and decrypts the traffic locally on the user's device using the organization's private keys. After decryption, the plaintext traffic is inspected locally by the agent application 110 for any threats or policy violations. Once inspection is complete, the traffic can be re-encrypted and forwarded to the cloud 120 for further processing or directly to the destination server. Security policies such as URL filtering, threat protection, and DLP are applied to the decrypted content, and if any malicious content or policy violations are detected, appropriate actions such as blocking access or alerting administrators are taken. For traffic that needs to be inspected in the cloud, the agent application 110 re-encrypts the traffic before sending it to the cloud 120, ensuring that the data remains encrypted during transit and is only decrypted when necessary.

The benefits of client-side decryption are numerous. Enhanced data privacy is maintained as sensitive data remains encrypted during transit until it reaches the endpoint, ensuring that it is not exposed even within the cloud infrastructure. Compliance with data protection regulations that mandate end-to-end encryption and strict handling of sensitive data is facilitated. Improved performance is achieved by decrypting and inspecting traffic locally, reducing latency and enhancing the performance of security inspections. Granular control allows organizations to define specific policies to control which traffic is decrypted and inspected, providing flexibility in managing different types of data and connections.

Use cases for client-side decryption include financial services, where sensitive financial data is protected by ensuring it is decrypted only at the end point to meet stringent regulatory requirements. In healthcare, patient information remains confidential by decrypting traffic on compliant devices, aligning with healthcare data privacy laws. In corporate environments, secure internet access is provided to employees while maintaining the confidentiality of corporate data. Client-side decryption in the cloud 120 is a powerful feature that combines robust security with enhanced data privacy. By decrypting traffic at the endpoint, it ensures sensitive information remains protected throughout its journey, while still allowing the cloud 120 to enforce security policies effectively. This approach addresses the growing need for securing encrypted traffic without compromising on performance or compliance.

As described, with traditional methods, when a client requests to visit a website, it first connects to the proxy and provides the Server Name Indication (SNI). The proxy then establishes a connection to the real web server and validates the server’s certificate to ensure it is legitimate. Next, the proxy completes the TLS handshake with the server, performing the necessary computational steps to establish a shared symmetric key. It then creates the “to be signed” (TBS) portion of a decryption certificate using its own RSA key, signs this certificate with a live Certificate Authority (CA) key, and proceeds to finalize the TLS handshake with the client—again doing the necessary computations to create a shared symmetric key, but this time with the client. After these handshakes are in place, the proxy decrypts messages from the client, processes the plaintext, and re-encrypts the messages before sending them to the server. The same process occurs in reverse when messages come from the server back to the client. These steps repeat until the session concludes.

When a decryption CA issues certificates, it must be trusted by every party relying on those certificates. A compromised key allows attackers to generate certificates that all relying parties would honor, thereby expanding the impact of a security breach. In a proxy-based model, the CA embedded within the proxy has to be trusted by every device that uses the proxy, creating a much larger “blast radius” in the event of a compromise.

By contrast, when client software on a user’s machine is responsible for issuing decryption certificates, only that machine needs to trust its local CA. If the client-specific issuing key is compromised, only that single endpoint is affected. This limited impact can be quickly addressed by prompting the client software to generate a new issuing key, drastically reducing both the severity and duration of the breach. Consequently, large organizations need not worry about one compromised key affecting all their users, and can instead focus on ensuring that each individual proxy certificate is valid. Trust in the proxy’s certificate can be verified via certificate transparency logs and WebTrust certifications, ensuring that no unexpected certificates are issued.

Shifting decryption responsibilities to the client also brings significant performance advantages. Proxies no longer need to perform public key operations, such as signing or continuous TLS handshakes, on behalf of each inbound client request. Instead, a single, long-lived connection can be established between the proxy and the client software. Since many organizations already deploy client software, these optimizations automatically benefit the majority of users.

With this approach, the proxy only needs to set up repeated handshakes on its outbound side (toward websites), effectively halving the cryptographic load in terms of session establishment. The client machine eliminates the proxy’s need to mint new decryption certificates for each connection, because the local client is the entity issuing and managing them. This streamlined process simplifies scaling up to large numbers of connections without overwhelming the proxy’s computational resources.

Client-side decryption also protects against insider threats within the service provider. If the proxy-side CA key were compromised, an attacker could theoretically generate certificates that would be trusted by every client. In a client-side model, however, the service provider does not possess the private key used to issue decryption certificates; only the individual client’s machine holds that key. Consequently, no single insider at the service provider can produce a certificate that would be universally trusted by all clients.

Moreover, each client machine generates a random, local CA key that remains strictly on that device. This key can be regenerated at any time without notifying or involving any external services. Consequently, if one endpoint’s key is compromised, that incident is contained to that specific machine, and the user or organization can rapidly rotate the key. This localized key management strategy significantly limits the potential scope of any insider attack.

By delegating certificate issuance to the client side, organizations can leverage the operating system and browser trust stores on each user’s device. This ensures that trust decisions align with policies already established by the organization’s IT department. Rather than replicating or syncing multiple trust stores on the proxy, the client software simply consults the native trust stores to validate certificates.

If the client’s local policy deems a server certificate invalid, the connection is abandoned right on the client, removing the need for complex handling at the proxy. This model lets each client enforce the exact certificate policies its administrator has configured and offers a clear line of visibility into which certificates are trusted.

When a server presents a certificate that the client’s policies consider invalid, the client itself can decide whether to proceed. It may generate a local, invalid MitM certificate for inspection if the user or organization explicitly allows “Connect Anyway” scenarios. In that case, the proxy only needs to pass data along, while the client logs the event and continues the connection according to local policy. This local decision-making framework empowers the organization to enforce compliance while still giving users the option to override warnings when justified, yet without forcing the proxy to maintain its own separate trust and inspection logic.

A major advantage of client-managed certificate issuance is the abundant resources available at the endpoint. Clients can generate unique decryption certificates for each connection, matching the key sizes, algorithms, and signature schemes used by the actual servers. This ensures TLS session parameters remain consistent on both the outbound proxy side and the client side.

When the proxy establishes a connection to a server and negotiates a ciphersuite, the proxy conveys that choice back to the client component. The client then applies the same ciphersuite to maintain full transparency. As a result, the browser sees the same encryption details, key size, public key algorithm, and signature scheme, that the proxy sees from the server. This gives users and administrators the ability to detect and challenge any discrepancies, while still supporting thorough inspection of traffic for security or compliance.

Finally, client software connected to a single proxy over a longer duration can automatically identify the proxy’s location via the proxy’s Distinguished Name (DN) or other metadata. This allows organizations to enforce policies about which countries or regions they are willing to route traffic through. Knowing where the proxy resides empowers the client to uphold geopolitical restrictions, acting as an additional safeguard beyond central cloud controls.

Based on the described benefits, moving decryption operations from the proxy to the client offers a compelling array of benefits. It narrows the blast radius in case of key compromise, reduces cryptographic overhead for the proxy, thwarts insider threats, respects established organizational trust stores, and allows for transparent, flexible handling of certificates and ciphersuites. Organizations gain more granular control over endpoint security, minimize the impact of potential compromises, and achieve better scalability, all while maintaining the same robust inspection capabilities.

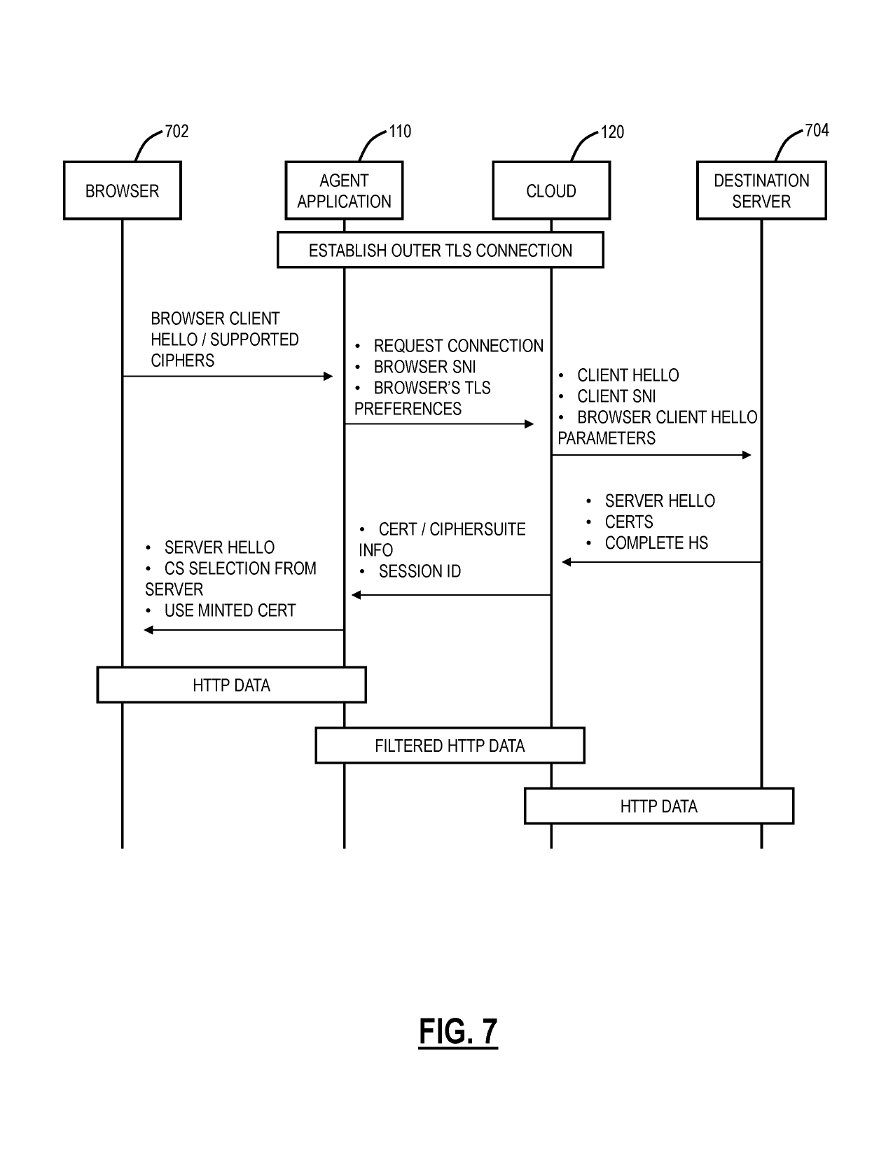

FIG. 7 is a flow diagram of an embodiment of the present systems and methods for client-side decryption. The process begins when the user’s browser 702 initiates a TLS handshake. The browser sends a Client Hello message and a list of supported cipher suites to the agent application 110, which resides on the same computing device 300. In this scenario, the agent application 110 is effectively acting as a proxy server for the browser. It receives the browser’s TLS preferences, including which ciphersuites, key exchange mechanisms, and extensions the browser supports.

After capturing the browser’s initial handshake parameters and Server Name Indication (SNI), the agent application 110 forwards these details to the cloud 120 (part of the security or proxy platform). Along with the connection request, it includes the browser’s TLS preferences to ensure that the node has all the information necessary to mirror the browser’s capabilities when connecting to the destination server 704. This approach preserves end-to-end visibility into the browser’s desired security settings.

Equipped with the SNI, the client’s TLS preferences, and the overall context of the requested connection, the cloud 120 (or a node of the cloud 120) then initiates a connection to the destination server 704. It sends its own Client Hello to the server, echoing the browser’s ciphersuite preferences and carrying the same SNI so that the server sees a consistent TLS setup. This step ensures that the node can negotiate a secure session with the server on behalf of the client. The destination server 704 responds with a Server Hello, providing the chosen ciphersuite, returning its certificate chain, and completing the server side of the TLS handshake. At this stage, the server has established a secure session with the cloud 120, and both parties have exchanged the necessary keys and parameters to encrypt the data going forward.

Once the cloud 120 has received the server’s handshake information, it sends back a message to the agent application 110. This message contains the server certificate chain that was just presented by the destination server, the final ciphersuite that was selected for the server-facing connection, and a session identifier or other connection details needed to maintain continuity between the node and the agent application

Armed with the server’s certificate data and final ciphersuite choice, the agent application generates a “minted” certificate, sometimes referred to as a “decryption” or “inspection” certificate, locally for the browser. This certificate effectively mirrors the important attributes (public key type, size, etc.) of the original server’s certificate, yet allows the agent application 110 to decrypt and inspect traffic. The agent application 110 then sends the browser 702 a Server Hello message matching the parameters from the real server’s handshake, the ciphersuite selection that the server ultimately chose, and the minted certificate, which the browser will treat as if it were the real server’s certificate for the purposes of establishing a local TLS session

From there, data exchange among the browser 702, agent application 110, cloud 120, and destination server 704 is as follows:

Browser 702 - Agent Application 110: The browser 702 now believes it is communicating directly with the destination server using the certificate from the agent application. All HTTP data is sent securely to the agent application for inspection or logging.

Agent Application 110 - Cloud 120: The agent application 110 then relays the (optionally filtered or inspected) HTTP data to the cloud 120 under the established secure session. Because the agent is effectively decrypting the traffic, it can perform local checks, filtering, or data manipulation according to organizational policies before re-encrypting and sending it on.

Cloud 120 - Destination Server 704: Finally, the cloud 120 delivers the client’s HTTP data to the actual destination server 704 over the secure TLS connection negotiated earlier. The server’s responses are also handled by the node and relayed back upstream, through the agent application 110, to the browser 702.

In various embodiments, the present client-side decryption process can be contemplated as various phases. During the connection phase, the client component first enrolls in a client certificate from a Public Key Infrastructure (PKI) or uses certificates from a PKI that the provider already trusts. This certificate, tied to the user’s identity, may also require proof of hardware-based protection through a Trusted Platform Module (TPM). By managing and maintaining this identity certificate, the client can establish a mutual TLS (mTLS) connection to a specific proxy. The proxy, in turn, presents its own identity certificate, which includes distinguishing information such as a unique proxy identity, product indicator, cloud or Organizational Unit (OU) details, and geographic indicators such as country and datacenter.

With these details, the client component can apply its policy-based logic to determine whether a particular proxy is acceptable. Since each client is configured to only trust or connect to proxies that meet certain criteria, malicious entities cannot simply redirect users to an unauthorized proxy without detection. If an attacker tries to reroute traffic to a rogue proxy, the client component’s configured policy checks will reject the connection due to a mismatch of identity details (for example, location or datacenter).

After the connection is established, the client component sends the ClientChoices Message to the proxy. This message specifies which TLS ciphersuites, key exchange mechanisms, and security parameters are acceptable to the client’s browser or underlying application. The proxy must then either create a new TLS session or reference an existing one that meets these exact requirements. Upon successfully creating or referencing a session, the proxy sends back a ServerChoice Message to detail the specific ciphersuite and key exchange mechanism it has selected on the outbound (server-facing) side.

By advertising its acceptable cipher suites, the client ensures that end-to-end security parameters remain consistent. Any subsequent handshake between the client component and the browser, where the client component acts as a local proxy, will reflect the same ciphersuite and security configurations, maintaining uniform protection and transparency throughout the communication chain.

The ServerChoice Message returns from the proxy to the client with a connection identifier and a description of the final TLS configuration established on the proxy’s server-facing side. This includes which ciphersuite has been chosen, the key exchange mechanism, and any other parameters relevant to the TLS session. Using this information, the client knows exactly how the proxy is communicating with the external server.

Because the client is effectively serving as a local “mini-proxy” for the browser, it needs to mimic these same choices in its own handshake with the browser. By aligning these TLS parameters, the browser is given an accurate representation of the cryptographic environment, reducing discrepancies and ensuring a consistent security posture.

Finally, the ServerCert Message provides the client with the Server Name Indication (SNI), sometimes called the “asserted server name”, as well as the full certificate chain presented by the remote server to the proxy. The client component can then verify this certificate chain against its local trust store or any other defined verification mechanism to confirm the server’s authenticity.

If the certificate chain is valid, the client component generates a corresponding certificate for the browser. This newly generated certificate matches the server’s public key size, public key algorithm, and signature algorithm, preserving essential characteristics that the browser expects to see. In doing so, the browser remains informed of critical certificate properties, such as key length and cryptographic algorithms, while the client and proxy continue to securely inspect and manage the traffic as needed.

### 7.1 Client side decryption process

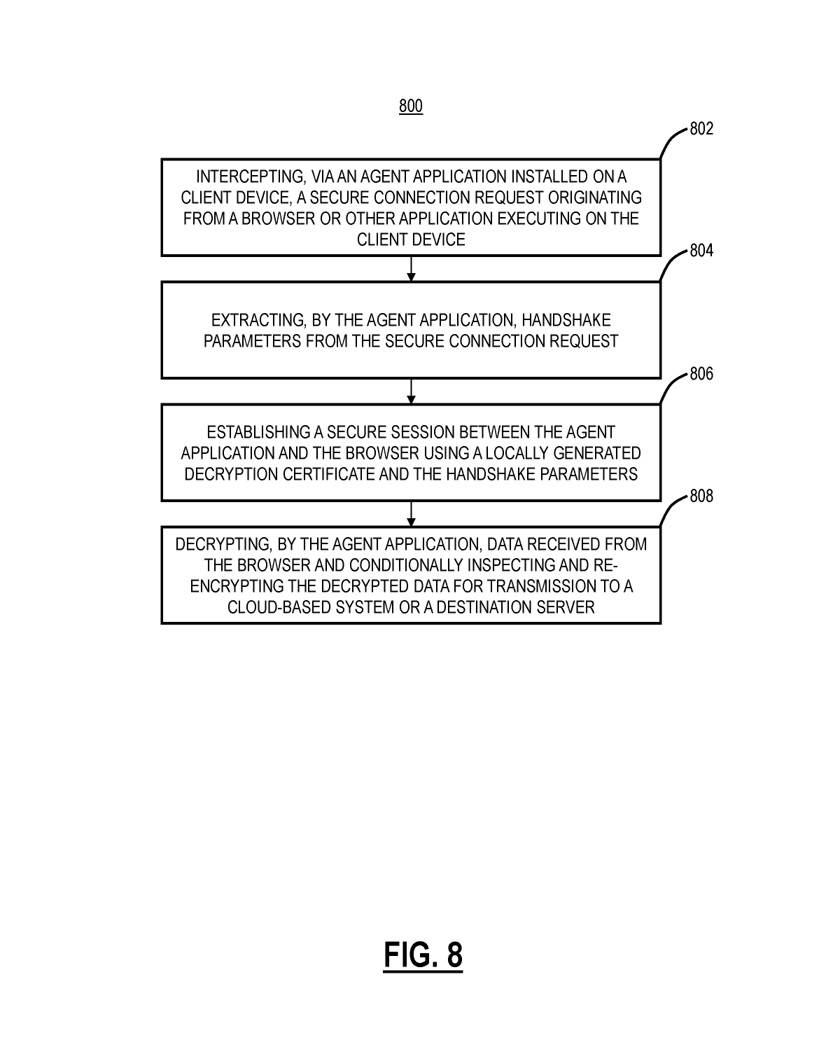

FIG. 8 is a flowchart of a process 800 for client-side decryption. In various embodiments, the process 800 can be contemplated as a method having steps, a processing device configured to implement the steps, a cloud-based system configured to implement the steps, and as a non-transitory computer-readable medium storing instructions for programming one or more processors to execute the steps. The process 800 includes intercepting, via an agent application installed on a client device, a secure connection request originating from a browser or other application executing on the client device (step 802); extracting, by the agent application, handshake parameters from the secure connection request (step 804); establishing a secure session between the agent application and the browser using a locally generated decryption certificate and the handshake parameters (step 806); decrypting, by the agent application, data received from the browser and conditionally inspecting and re-encrypting the decrypted data for transmission to a cloud-based system or a destination server (step 808).

The process 800 further includes wherein the handshake parameters include a Server Name Indication (SNI) and cipher suite preferences. Establishing a secure session can include forwarding, from the agent application to the cloud-based system, the handshake parameters, a Server Name Indication (SNI), and cipher suite preferences; receiving, at the agent application from the cloud-based system, a response indicating a finalized server-facing Transport Layer Security (TLS) configuration, the configuration including a chosen cipher suite, a certificate chain, and any relevant session details; and locally generating, by the agent application, a decryption certificate derived from the server-facing certificate chain and mirroring essential cryptographic attributes of the server-facing certificate. The steps can include verifying, at the agent application, an authenticity of the certificate chain presented by the destination server against a local or operating system-level trust store prior to locally generating the decryption certificate. The locally generated decryption certificate can be signed by a local Certificate Authority (CA) key stored securely on the client device, the local CA key being different from a cloud-based or network-based CA key. The steps can further include performing policy-based inspection on decrypted data, including at least one of threat detection, Data Loss Prevention (DLP), or Uniform Resource Locator (URL) filtering, prior to re-encrypting the data for forwarding. The steps can include establishing, via the agent application, a second secure session with the cloud-based system, such that decrypted data is re-encrypted before leaving the client device, thereby maintaining confidentiality in transit.

### 8.0 Processing circuitry and non transitory computer readable mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits "configured to" or "adapted to" execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### 9.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method comprising steps of:
intercepting, via an agent application installed on a client device, a secure connection request originating from a browser or other application executing on the client device;
extracting, by the agent application, handshake parameters from the secure connection request;
establishing a secure session between the agent application and the browser using a locally generated decryption certificate and the handshake parameters; and
decrypting, by the agent application, data received from the browser and conditionally inspecting and re-encrypting decrypted data for transmission to a cloud-based system or a destination server.

2. The method of claim 1, wherein the handshake parameters include a Server Name Indication (SNI) and cipher suite preferences.

3. The method of claim 1, wherein establishing a secure session comprises:
forwarding, from the agent application to the cloud-based system, the handshake parameters, a Server Name Indication (SNI), and cipher suite preferences;
receiving, at the agent application from the cloud-based system, a response indicating a finalized server-facing Transport Layer Security (TLS) configuration, the configuration including a chosen cipher suite, a certificate chain, and any relevant session details; and
locally generating, by the agent application, a decryption certificate derived from the certificate chain and mirroring essential cryptographic attributes of the certificate.

4. The method of claim 3, wherein the steps comprising verifying, at the agent application, an authenticity of the certificate chain presented by the destination server against a local or operating system-level trust store prior to locally generating the decryption certificate.

5. The method of claim 1, wherein the locally generated decryption certificate is signed by a local Certificate Authority (CA) key stored securely on the client device, the local CA key being different from a cloud-based or network-based CA key.

6. The method of claim 1, wherein the steps further comprise performing policy-based inspection on decrypted data, including at least one of threat detection, Data Loss Prevention (DLP), or Uniform Resource Locator (URL) filtering, prior to re-encrypting the data for forwarding.

7. The method of claim 1, wherein the steps comprise establishing, via the agent application, a second secure session with the cloud-based system, such that decrypted data is re-encrypted before leaving the client device, thereby maintaining confidentiality in transit.

8. A non-transitory computer-readable medium comprising instructions that, when executed, cause one or more processors to perform steps of:
intercepting, via an agent application installed on a client device, a secure connection request originating from a browser or other application executing on the client device;
extracting, by the agent application, handshake parameters from the secure connection request;
establishing a secure session between the agent application and the browser using a locally generated decryption certificate and the handshake parameters; and
decrypting, by the agent application, data received from the browser and conditionally inspecting and re-encrypting decrypted data for transmission to a cloud-based system or a destination server.

9. The non-transitory computer-readable medium of claim 8, wherein the handshake parameters include a Server Name Indication (SNI) and cipher suite preferences.

10. The non-transitory computer-readable medium of claim 8, wherein establishing a secure session comprises:
forwarding, from the agent application to the cloud-based system, the handshake parameters, a Server Name Indication (SNI), and cipher suite preferences;
receiving, at the agent application from the cloud-based system, a response indicating a finalized server-facing Transport Layer Security (TLS) configuration, the configuration including a chosen cipher suite, a certificate chain, and any relevant session details; and
locally generating, by the agent application, a decryption certificate derived from the certificate chain and mirroring essential cryptographic attributes of the certificate.

11. The non-transitory computer-readable medium of claim 10, wherein the steps comprising verifying, at the agent application, an authenticity of the certificate chain presented by the destination server against a local or operating system-level trust store prior to locally generating the decryption certificate.

12. The non-transitory computer-readable medium of claim 8, wherein the locally generated decryption certificate is signed by a local Certificate Authority (CA) key stored securely on the client device, the local CA key being different from a cloud-based or network-based CA key.

13. The non-transitory computer-readable medium of claim 8, wherein the steps further comprise performing policy-based inspection on decrypted data, including at least one of threat detection, Data Loss Prevention (DLP), or Uniform Resource Locator (URL) filtering, prior to re-encrypting the data for forwarding.

14. The non-transitory computer-readable medium of claim 8, wherein the steps comprise establishing, via the agent application, a second secure session with the cloud-based system, such that decrypted data is re-encrypted before leaving the client device, thereby maintaining confidentiality in transit.

15. A client device comprising:
one or more processors; and
memory storing computer-executable instructions that, when executed, cause the one or more processors to:
intercept, via an agent application installed on the client device, a secure connection request originating from a browser or other application executing on the client device;
extract, by the agent application, handshake parameters from the secure connection request;
establish a secure session between the agent application and the browser using a locally generated decryption certificate and the handshake parameters; and
decrypt, by the agent application, data received from the browser and conditionally inspect and re-encrypt decrypted data for transmission to a cloud-based system or a destination server.

16. The client device of claim 15, wherein the handshake parameters include a Server Name Indication (SNI) and cipher suite preferences.

17. The client device of claim 15, wherein establishing a secure session comprises:
forwarding, from the agent application to the cloud-based system, the handshake parameters, a Server Name Indication (SNI), and cipher suite preferences;
receiving, at the agent application from the cloud-based system, a response indicating a finalized server-facing Transport Layer Security (TLS) configuration, the configuration including a chosen cipher suite, a certificate chain, and any relevant session details; and
locally generating, by the agent application, a decryption certificate derived from the certificate chain and mirroring essential cryptographic attributes of the certificate.

18. The client device of claim 17, wherein the instructions further cause the one or more processors to verify, at the agent application, an authenticity of the certificate chain presented by the destination server against a local or operating system-level trust store prior to locally generating the decryption certificate.

19. The client device of claim 15, wherein the locally generated decryption certificate is signed by a local Certificate Authority (CA) key stored securely on the client device, the local CA key being different from a cloud-based or network-based CA key.

20. The client device of claim 15, wherein the instructions further cause the one or more processors to perform policy-based inspection on decrypted data, including at least one of threat detection, Data Loss Prevention (DLP), or Uniform Resource Locator (URL) filtering, prior to re-encrypting the data for forwarding.
